(19) United States
(12) Patent Application Publication
(10) Pub. No.: US 2011/0026885 A1
(43) Pub. Date: Feb. 3, 2011

(54) OPTICAL FIBER COUPLING CONNECTOR

(75) Inventor: I-THUN LIN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/732,215

(22) Filed: Mar. 26, 2010

(30) Foreign Application Priority Data
Jul. 31, 2009 (CN) 200910305034.0

(51) Int. Cl. G02B 6/36

(52) U.S. Cl. 385/77

(57) ABSTRACT

An exemplary optical fiber coupling connector includes a receptacle and a plug for insertion into the receptacle. The receptacle includes a first transmission optical fiber and a first receiving optical fiber. The plug includes a second transmission optical fiber for optically coupling with the first receiving optical fiber, and a second receiving optical fiber for optically coupling with the first transmission optical fiber. A core of the first transmission optical fiber is narrower than that of the second receiving optical fiber, and a core of the second transmission optical fiber is narrower than that of the first receiving optical fiber.

### BACKGROUND

1. Technical Field

The present disclosure relates to connectors, and particularly, to an optical fiber coupling connector.

2. Description of Related Art

Following rapid development of computer technology, a variety of sophisticated computers and computer peripheral apparatuses have been disclosed. When connecting a computer peripheral apparatus, such as a scanner, a digital camera, a mobile phone, a music player, etc., to a host computer, an optical fiber coupling connector is generally used as an interface for high-speed transmission of electronic data. To improve transmission efficiency, lower transmission loss is desired. Therefore, it is necessary to provide a fiber coupling connector having low transmission loss.

### BRIEF DESCRIPTION OF THE DRAWINGS

Many aspects of the present optical fiber coupling connector can be better understood with reference to the following drawings. The components in the drawings are not necessarily drawn to scale, the emphasis instead being placed upon clearly illustrating the principles of the present optical fiber coupling connector. Moreover, in the drawings, like reference numerals designate corresponding parts throughout the several views.

FIG. 1 is an isometric view of a receptacle of an optical fiber coupling connector in accordance with an exemplary embodiment, the optical fiber coupling connector having a metallic sheath and an outer shell.

FIG. 2 is a top view of the receptacle of FIG. 1 after taking away a portion of the metallic sheath and the outer shell.

FIG. 3 is a bottom schematic view of the receptacle of FIG. 2.

FIG. 4 is an isometric view of a plug of the optical fiber coupling connector in accordance with the exemplary embodiment.

FIG. 5 shows optically coupling between optical fibers when the plug of FIG. 4 is inserted into the receptacle of FIG. 1.

### DETAILED DESCRIPTION

Embodiment of the present optical fiber coupling connector will now be described in detail below and with reference to the drawings. The optical fiber coupling connector includes a plug and a receptacle. The plug is generally assembled in a host computer, and the receptacle is portable and configured for coupling with the plug such that data is inter-transmitted between the host computer and the computer peripheral apparatus.

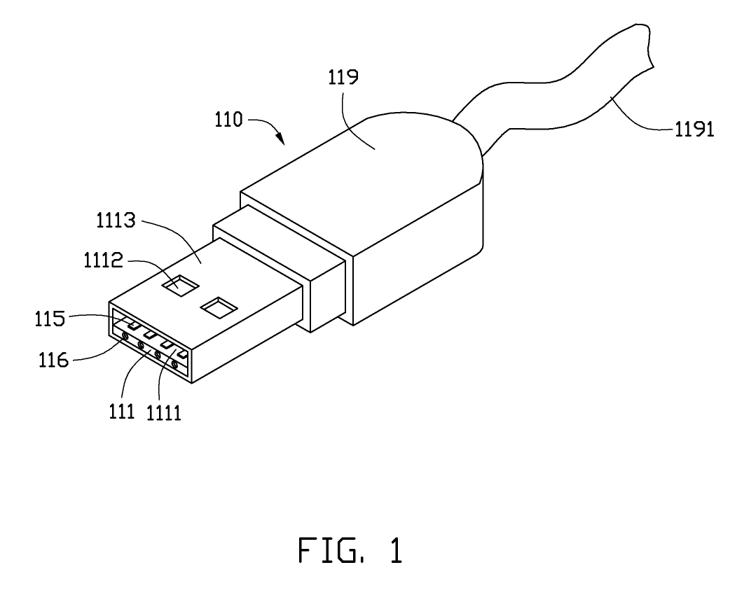

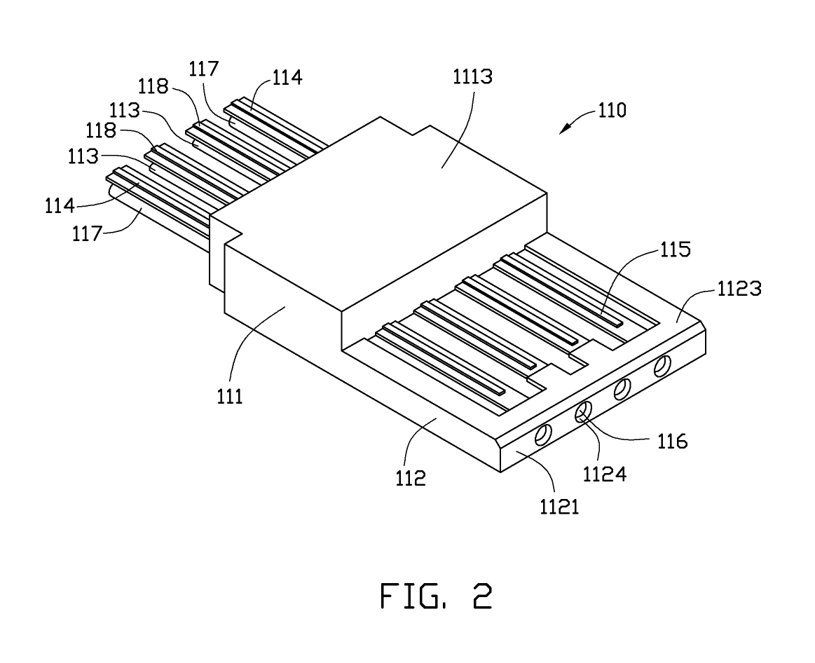

Referring to FIGS. 1, 4 and 5, an optical fiber coupling connector 100 is provided in an exemplary embodiment, including a receptacle 110 and a plug 120 for insertion into the receptacle 110. Referring to FIG. 2, the receptacle 110 includes two first transmission optical fibers 113 and two first receiving optical fibers 117 each parallel to the respective two first transmission optical fibers 113. In addition, the two first transmission optical fibers 113 are fixed between the two first receiving fibers 117.

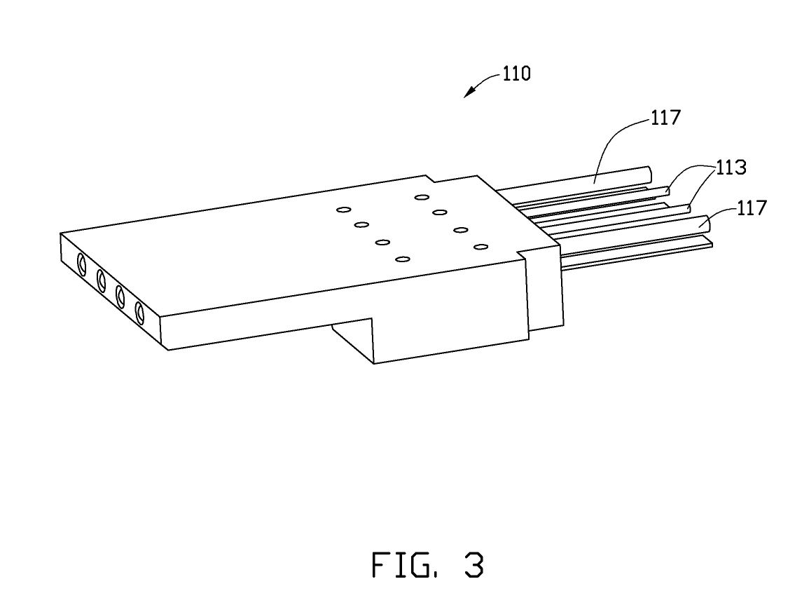

Referring to FIGS. 1, 2 and 3, the receptacle 110 further includes an enclosing metallic sheath 111, an insulated plastic tongue 112, two electrical conductors 114, two data suppliers 118, four pins 115, four first lenses 116, a plastic shell 119 and a cable 1191.

The metallic sheath 111, partially accommodated in the shell 119, has a chamber 1111 and an insertion surface 1113. The metallic sheath 111 also defines two openings 1112 in the insertion surface 1113. The openings 1112 communicate with the chamber 1111 for engaging with the plug 120.

Referring to FIGS. 1 and 2, the tongue 112 is accommodated in the chamber 1111 of the metallic sheath 111. The tongue 112 is board shaped, having a first end surface 1121, a second end surface (not labeled), and a fixing surface 1123 interconnecting the first end surface 1121 and the second end surface. The fixing surface 1123 is parallel to the insertion surface 1113 of the metallic sheath 111. Additionally, the tongue 112 has four first grooves 1124 each passing through the first end surface 1121 and the second end surface. The first grooves 1124 are configured for accommodating the first transmission optical fibers 113 and the first receiving optical fibers 117.

The two electrical conductor 114, the two data suppliers 118 and four pins 115 are embedded in the fixing surface 1123 of the plastic tongue 112. The two electrical conductors 114 are parallel to each other, extending from the second end surface and ending intermediately. The two data suppliers 118 are located between the two electrical conductors 114 with respectively parallel thereto. The four pins 115 are aligned with and electrically connected to the two electrical conductors 114 and the two data suppliers 118.

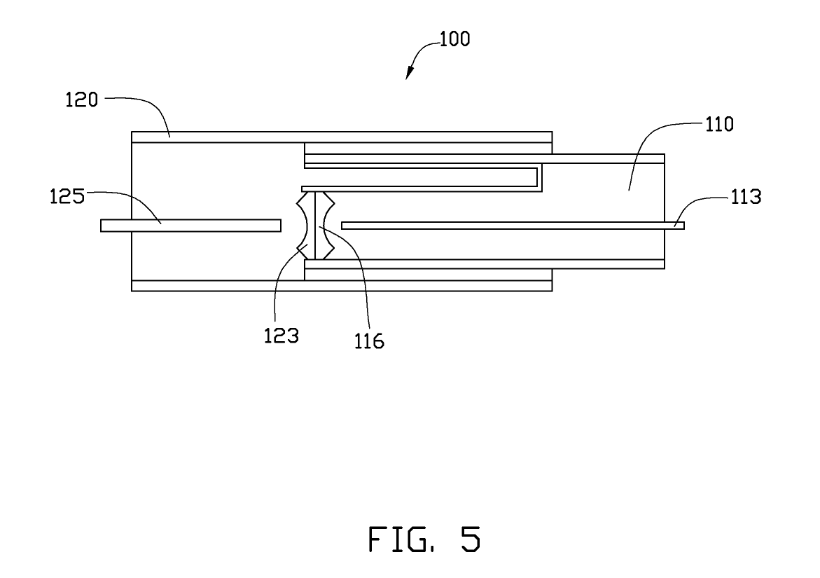

The two first transmission optical fibers 113, the two first receiving optical fibers 117 and the four first lenses 116 are accommodated in the first grooves 1124. Referring to FIG. 2, the two first transmission optical fibers 113 correspond to the data suppliers 118, and the first receiving optical fibers 117 correspond to the electrical conductors 114. The first lenses 116 are exposed to the exterior at the first end surface 1121. To be convenient, taking one of the two first transmission optical fibers 113 and one of the four first lenses 116 for instance, referring to FIG. 5, the first lens 116 is one-side-concave-and-one-side-flat. The first transmission optical fiber 113 is coaxial with the first lens 116 with one end thereof adjacent to the concave side and at focus with the first lens 116. Each of first transmission optical fibers 113 and the first receiving optical fibers 117 has a similar structure with a typical optical fiber, i.e., including an inner core for transmitting signals, an outer insulated layer, and an intermediate glass fiber. The core of the first transmission optical fiber 113 is narrower than that of the first receiving fiber 117. For instance, a diameter of the core of the first transmission optical fiber 113 can be about 62.5 micrometers, and that of the core of the first receiving optical fiber 117 can be about 80 or 125 micrometers.

The cable 1191 wraps the two first transmission optical fibers 113, and the two first receiving optical fibers 117. In addition, the cable 1191 also wraps two shielding wires for supplying power. Each of the two shielding wires connects with a corresponding two electrical conductors 114.

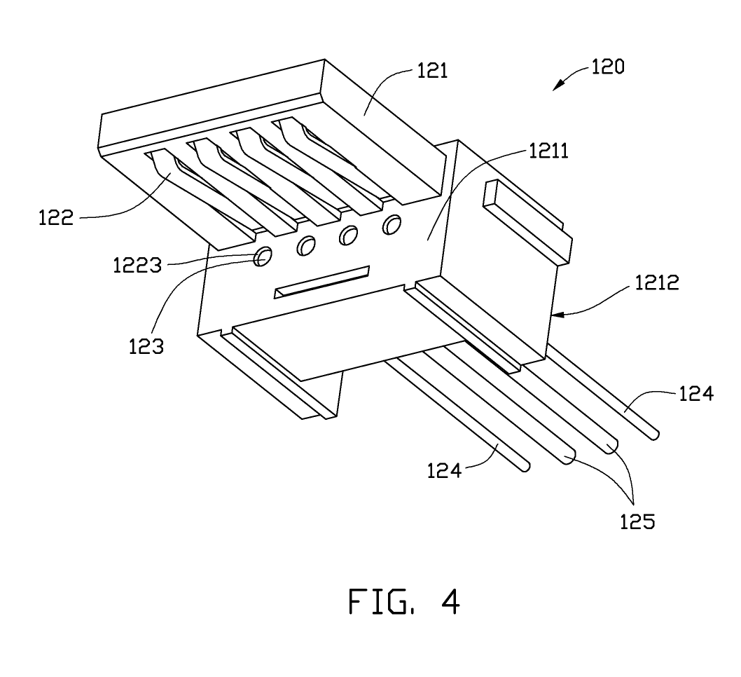

Referring to FIG. 4, the plug 120 includes an insulated carrying panel 121, four elastic connectors 122, four second lenses 123, two second transmission optical fibers 124, and two second receiving optical fibers 125.

The carrying panel 121 has a coupling surface 1211 for contacting the first end surface 1121 of the receptacle 110, an end surface 1212 opposite to the coupling surface 1211, and four second grooves 1223 passing through the coupling surface 1211 and the end surface 1212.

The two second transmission optical fibers 124, the two second receiving optical fibers 125 and the second lenses 123 are accommodated in the second grooves 1223. In detail, Referring to FIG. 4, each second lens 123 is exposed to the exterior at the coupling surface 1211, the two second transmission optical fibers 124 and the two receiving optical fibers 125 are parallel to each other, and the two second receiving optical fibers 125 are located between the two second transmission optical fibers 124. To be convenient, taking one of the two receiving optical fibers 125 and one of the second lenses 123 for example, referring to FIG. 5, the second lens 123 is one-side-concave-and-one-side-flat. The second receiving optical fiber 125 is coaxial with the second lens 123 with one end thereof adjacent to the concave side and at a focus of the second lens 123. The second transmission optical fibers 124 are configured for coupling with the respective first receiving optical fibers 117 through the first lenses 116 and the second lenses 123. Each second receiving optical fiber 125 is configured for coupling with the corresponding first transmission optical fiber 113 through the first lens 116 and second lens 123. A diameter of a core of the second transmission optical fiber 124 is about 62.5 micrometers, and a diameter of a core of the second receiving optical fiber 125 is about 80 micrometers.

Referring to FIG. 4, the elastic connector 122 embeds the carrying panel 121, and is adjacent to the coupling surface 1211. The elastic connector 122 is made of electrically conductive metal, configured for detachably engaging the metallic sheath 111 of the receptacle 110 by inserting into the opening 1112.

When in use, the plug 120 inserts the receptacle 110, and the elastic connector 122 is engaged in the metallic sheath 111. Also referring to FIG. 5, the first transmission optical fiber 113 is coupled with the second receiving optical fiber 125 through the first lens 116 and the second lens 123. In this manner, optical signals can be transmitted between a host computer and a computer peripheral apparatus. In detail, the first transmission optical fiber 113 transmits the signals from the host computer to the first lens 116, the first lens 116 spreads the signals, the second lens 123 straightens the signals, and the second receiving optical fiber 124 receives the signals and transmits them into the computer peripheral apparatus. It is understood that signals are simultaneously transmitted from the computer peripheral apparatus to the host computer.

1 lumen light beams and a lighttools™ software (provided by American optical research associates company) are used for testing a transmission loss of the optical fiber coupling connector 100 and that of a typical optical fiber coupling connector. The typical optical fiber coupling connector means that diameters of the cores of the transmission optical fiber and the receiving optical fiber thereof are both 62.5 micrometers. In a test method, the 1 lumen light beams is transmitted from the first transmission optical fiber 113 to the second receiving optical fiber 125, and the light beams arriving at the second receiving optical fiber 125 are collected.

The test results show that the light beam arrives at the second receiving optical fiber 125 is 0.85 lumen while arriving at the receiving optical fiber of the typical optical fiber coupling connector is 0.83 lumen. Therefore, compared with the typical optical fiber coupling connector, the present optical fiber coupling connector 100 has lower transmission loss.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A fiber coupling connector comprising a receptacle and a plug for insertion into the receptacle, the receptacle comprising a first transmission optical fiber and a first receiving optical fiber, the plug comprising a second transmission optical fiber for optically coupling with the first receiving optical fiber, and a second receiving optical fiber for optically coupling with the first transmission fiber, a core of the first transmission optical fiber being narrower than that of the second receiving optical fiber, and a core of the second transmission optical fiber being narrower than that of the first receiving optical fiber.

2. The fiber coupling connector of claim 1, wherein a diameter of the core of both the first transmission optical fiber and the second transmission optical fiber is 62.5 micrometers, and that of the core of both the first receiving optical fiber and the second receiving optical fiber is 80 micrometers.

3. The fiber coupling connector of claim 1, wherein a diameter of the core of both the first transmission optical fiber and the second transmission optical fiber is 62.5 micrometers, and that of the core of both the first receiving optical fiber and the second receiving optical fiber is 125 micrometers.
